(19) United States
(12) Patent Application Publication
(10) Pub. No.: US 2024/0186582 A1
(43) Pub. Date: Jun. 6, 2024

(54) Solid-liquid Composite Electrolyte including Sulfide-based Solid Electrolyte and Liquid Electrolyte, and Semi-solid-state Rechargeable Batteries

(71) Applicant: UIF (University Industry Foundation), Yonsei University, Seoul (KR)

(72) Inventors: Sang-Young Lee, Seoul (KR); Won-Yeong Kim, Seoul (KR); Kyeong-Seok Oh, Seoul (KR); Seokhyeon Yu, Seoul (KR)

(21) Appl. No.: 18/524,006

(22) Filed: Nov. 30, 2023

(30) Foreign Application Priority Data
Dec. 1, 2022 (KR) 10-2022-0166000
Nov. 8, 2023 (KR) 10-2023-0154002

(51) Int. Cl. H01M 10/0569; H01M 10/0562; H01M 10/0568

(52) U.S. Cl. CPC H01M 10/0569; H01M 10/0562; H01M 10/0568; H01M 2300/0034; H01M 2300/0037; H01M 2300/008; H01M 2300/0091

(57) ABSTRACT

Disclosed are a solid-liquid composite electrolyte, and a semi-solid secondary battery including the same, the solid-liquid composite electrolyte including a sulfide-based solid electrolyte and a liquid electrolyte, wherein the liquid electrolyte includes a salt and a fluorinated organic solvent that dissolves the salt.

### CROSS-REFERENCE TO RELATED APPLICATION

This application claims priority to and the benefit of Korean Patent Application No. 10-2022-0166000 filed in the Korean Intellectual Property Office on Dec. 1, 2022, and Korean Patent Application No. 10-2023-0154002 filed in the Korean Intellectual Property Office on Nov. 8, 2023, the entire contents of which are incorporated herein by reference.

### BACKGROUND OF THE INVENTION

### (a) Field of the Invention

A solid-liquid composite electrolyte including a sulfide-based solid electrolyte and a liquid electrolyte, and a semi-solid secondary battery are disclosed.

### (b) Description of the Related Art

General secondary batteries use a flammable electrolyte and have a safety issue such as explosion or fire, when problems such as collision or penetration, etc. occur. Accordingly, all-solid secondary batteries or semi-solid secondary batteries using a solid electrolyte instead of an electrolyte solution are being proposed. The batteries using solid electrolytes are safe with no risk of explosion due to electrolyte leakage and have an advantage of being easily manufactured into thin batteries, in which a negative electrode thickness may be reduced, improving rapid charging and discharging performance and realizing high-voltage driving and high energy density. In particular, sulfide-based solid electrolytes have recently attracted much attention due to their high ionic conductivity comparable with liquid electrolytes and high transference number (t_{Li+}≈1).

However, the sulfide-based solid electrolyte has a problem of deterioration of ionic conductivity performance due to resistance generated on the interface with other solid particles such as a positive electrode active material and the like in the batteries and a depletion layer formed by joining the solids.

Accordingly, research on solving the problems of the solid electrolyte is underway by adding a liquid electrolyte to the sulfide-based solid electrolyte to prepare a solid-liquid composite electrolyte. However, conventional studies to combine the sulfide-based solid electrolyte with the liquid electrolyte have the following limitations. First, a chemical side reaction on the interface of the liquid electrolyte, which is generally highly polar, with the sulfide-based solid electrolyte, second, high resistance against movement of lithium ions on the interface of the liquid electrolyte with the sulfide-based solid electrolyte, third, deterioration of single ionic conductivity due to a low lithium ion yield (Li⁺ transference number) of the liquid electrolyte, forth, flame retardant loss due to introduction of the liquid electrolyte, which is flammable, into the sulfide-based solid electrolyte, and fifth, low high-voltage oxidation stability of conventional composite electrolytes, resulting in an unstable interface with a positive electrode.

### SUMMARY OF THE INVENTION

Some embodiments provide a solid-liquid composite electrolyte that can be applied to practical batteries by reducing side reactions between a sulfide-based solid electrolyte and a liquid electrolyte, maintaining high ionic conductivity, and ensuring oxidation stability, heat resistance, and flame retardancy, and a semi-solid secondary battery including the same.

In some embodiments, a solid-liquid composite electrolyte includes a sulfide-based solid electrolyte and a liquid electrolyte, wherein the liquid electrolyte includes a salt and fluorinated organic solvent that dissolves the salt.

Some embodiments provide a semi-solid secondary battery including a positive electrode, a negative electrode, and the solid-liquid composite electrolyte.

The solid-liquid composite electrolyte according to some embodiments has fewer side reactions between the sulfide-based solid electrolyte and the liquid electrolyte, can maintain high ionic conductivity, and has oxidation stability, heat resistance, and flame retardancy at the same time, so it can be applied to practical batteries and improves reliability and cycle-life characteristics of the battery.

### BRIEF DESCRIPTION OF THE DRAWINGS

FIG. 1 is an image schematically showing a semi-solid secondary battery according to some embodiments.

### DETAILED DESCRIPTION OF THE EMBODIMENTS

Hereinafter, specific embodiments will be described in detail so that those skilled in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

An average particle diameter may be measured by a method well known to those skilled in the art, for example, may be measured by a particle size analyzer, or may be measured by a transmission electron microscopic image or a scanning electron microscopic image. Alternatively, it is possible to obtain an average particle diameter value by measuring it using a dynamic light scattering method, performing data analysis, counting the number of particles for each particle size range, and calculating from this. As used herein, when a definition is not otherwise provided, the average particle diameter may mean a diameter (D₅₀) of particles having a cumulative volume of 50 vol % in a particle size distribution.

Herein, “or” is not to be construed as an exclusive meaning, for example, “A or B” is construed to include A, B, A+B, and the like.

“Metal” is interpreted as a concept that includes ordinary metals, transition metals, and metalloids (semi-metals).

### Solid-Liquid Composite Electrolyte

A solid-liquid composite electrolyte according to some embodiments includes a sulfide-based solid electrolyte and a liquid electrolyte, wherein the liquid electrolyte includes a salt and a fluorinated organic solvent that dissolves the salt.

The solid-liquid composite electrolyte is a mixture or composite of a sulfide-based solid electrolyte and a liquid electrolyte, and may be expressed as a hybrid electrolyte or hybrid electrolyte. The solid electrolyte and the liquid electrolyte may be physically mixed or chemically bonded to each other. For example, the liquid electrolyte may be disposed in pores between a plurality of solid electrolyte particles. Or the liquid electrolyte may be located on the surface of the solid electrolyte particles and may be attached, adsorbed, connected, or bonded to at least a portion of the surface of the solid electrolyte particles, for example, surround the surface of the solid electrolyte particles in the form of a film.

### Liquid Electrolyte

In the solid-liquid composite electrolyte according to some embodiments, the liquid electrolyte includes a salt and a fluorinated organic solvent that dissolves the salt.

The biggest problem in combining the sulfide-based solid electrolyte and the liquid electrolyte is that the sulfide-based solid electrolyte and the liquid electrolyte chemically react to form a resistance layer, which reduces ionic conductivity. The liquid electrolyte includes a solvent, which is mainly polar, and this polar solvent strongly interacts with the sulfide-based solid electrolyte and thus easily causes a side reaction. For example, when a liquid electrolyte prepared by dissolving 1 M LiPF₆ in a carbonate-based solvent such as ethylene carbonate or propylene carbonate, etc. is combined with the sulfide-based solid electrolyte, since the liquid electrolyte and the solid electrolyte have high reactivity, which may cause a side reaction to form a resistance layer, ionic conductivity is rapidly deteriorated as reaction time goes.

Accordingly, recent studies have been conducted in the direction of selecting non-polar solvents rather than polar solvents, or solvents that are chemically stable with sulfide-based solid electrolytes, but even in this case, a decrease in ionic conductivity according to reaction time is not significantly reduced or there are limits to commercialization.

As another alternative, a solvent-in-salt in which a ratio of a weight of the salt to a weight of the organic solvent is 1 or more has been proposed. For example, attempts have been made to prepare a liquid electrolyte by dissolving lithium salts such as LiTFSI and LiBETI in an organic solvent at a very high concentration and combining it with a sulfide-based solid electrolyte. The solvent-in-salt liquid electrolytes may be chemically stable due to low side reactions with sulfide-based solid electrolytes, but their cost is too high to limit commercialization, and due to their high viscosity, it is difficult to impregnate the voids between the sulfide-based solid electrolyte particles and to inject into the battery, which worsens the processability.

As another alternative, mixing an ionic liquid with a sulfide-based solid electrolyte instead of or in addition to the liquid electrolyte has been considered. However, in this case, although chemical stability can be increased, there is a problem of a high decrease in ionic conductivity with reaction time and a decrease in flame retardancy and heat resistance. Likewise, the cost of ionic liquid is too high, and thus there is a limit to its application in actual batteries.

Accordingly, the present invention is to propose a composite electrolyte that not only improves ionic conductivity by suppressing side reactions between sulfide-based solid electrolyte and liquid electrolyte, but also improves high-voltage oxidation stability, heat resistance, and flame retardancy, and secures economic feasibility, so that it can be applied to practical batteries.

### Fluorinated Organic Solvent That Dissolves the Salt

The liquid electrolyte according to some embodiments uses a fluorinated organic solvent as an organic solvent, that is, an organic solvent in which at least one fluorine is substituted, and among them, a fluorinated organic solvent capable of dissolving a salt. The“fluorinated organic solvent that dissolves the salt” according to some embodiments has low reactivity with sulfide-based solid electrolytes, thereby increasing the chemical stability of the solid-liquid composite electrolyte and improving an ionic conductivity retention rate over reaction time. In addition, since the solvent has high flame retardancy and high thermal stability, the problem of loss or deterioration of flame retardancy due to the addition of liquid electrolyte may be prevented, and fire safety, which is an advantage of using a solid electrolyte, may be maintained. When applying the solvent, the viscosity of the liquid electrolyte is lower than that of a solvent-in-salt or a high-concentration liquid electrolyte, so it is advantageous for impregnation into solid electrolyte particles, or into the positive electrode or negative electrode, and processability may be improved. Furthermore, the solvent according to some embodiments has high oxidation stability, so that side reactions at the interface between the electrolyte and the positive electrode are small even in the high voltage range, and thus, it is possible to drive the semi-solid battery stably in the entire voltage range.

The dissolving of a salt may mean, for example, that 0.1 mol or more or 0.5 mol or more of a salt is completely dissolved in 1 L of solvent, or that 0.1 mol or more or 0.5 mol or more of a salt is completely dissolved in 1 kg of solvent.

Specifically, when the salt is dissolved at a concentration of about 1 m or more using only a fluorinated organic solvent that dissolves the salt as the sole solvent, the ionic conductivity of the solution may be about 1×10⁻⁴ S/cm or more. This means that the fluorinated organic solvent can dissolve salts, is suitable for application to the solid-liquid composite electrolyte according to some embodiments, and realizes excellent ionic conductivity in the battery. For example, an ionic conductivity of a solution in which the salt is dissolved using only a fluorinated organic solvent dissolving the salt as the sole solvent may be about 10⁻² S/cm to about 10⁻⁴ S/cm, for example, about 10⁻² S/cm to about 10⁻³ S/cm, or about 10⁻³ S/cm to about 10⁻⁴ S/cm.

Herein, the salt refers to a salt including a metal cation and an anion paired therewith, and may refer to a salt according to some embodiments described in detail later, as an example, LiFSI (lithium bis(fluorosulfonyl)imide). In addition, under a temperature condition of 25° C., it may mean the ionic conductivity value in the entire concentration range of approximately 0.5 m to 20 m, for example, it may be a value measured at a concentration of about 1 m. For example, when 1 m of LiFSI is dissolved using only a fluorinated organic solvent that dissolves the salt as the sole solvent, an ionic conductivity of greater than or equal to about 10⁻⁴ S/cm can be exhibited. Herein, the ionic conductivity may be measured through electrochemical impedance spectroscopy (EIS), in which it is analyzed, for example, under the conditions of an amplitude of about 10 mV, a frequency of about 1 MHz to about 100 mHz, an air atmosphere, and about 25° C.

A concentration of a solution in which the salt is dissolved using only the fluorinated organic solvent that dissolves the salt as the sole solvent may be greater than or equal to about 0.1 m, for example, greater than or equal to about 0.5 m, or greater than or equal to about 1 m. This means that it can be defined as a solvent that dissolves the salt when the concentration is 0.1 m or more. Herein, a concentration of the solution refers to a concentration at 25° C. and normal pressure. Specifically, the concentration of a solution in which the salt is dissolved using only the fluorinated organic solvent that dissolves the salt as the sole solvent may be about 0.1 m to about 20 m, about 0.2 m to about 20 m, about 0.5 m to about 20 m, or about 1 m to about 20 m. Herein, the salt may refer to a salt according to some embodiments described later, and may be LiFSI as an example. That is, for example, when LiFSI is dissolved at normal pressure at 25° C. using a fluorinated organic solvent that dissolves the salt as the sole solvent, the concentration may be about 0.1 m or more or about 0.5 m or more.

A fluorinated organic solvent that does not dissolve a salt may mean, for example, a solvent that is not recognized as substantially dissolving the salt because the concentration is measured to be less than about 0.1 m when the salt is mixed with the solvent. For example, research on adding highly fluorinated ethers, such as 1,1,2,2-tetrafluoroethyl-2,2,3,3-tetrafluoropropyl ether (TTE), which cannot dissolve existing salts, to composite electrolytes has been proposed, but it cannot be used as a sole solvent because it does not substantially dissolve salts, it is difficult to consider it as a solvent for liquid electrolytes, and because other existing organic solvents should be basically used, it is difficult to secure flame retardancy and oxidation stability and it may require high costs.

The fluorinated organic solvent that dissolves the salt according to some embodiments may specifically include fluorinated ether, fluorinated phosphate, fluorinated carbonate, or a combination thereof.

These solvents are those in which one or more fluorines in the chemical formula are substituted, but are not highly fluorinated compounds. For example, the fluorinated organic solvent that dissolves the salt according to some embodiments may have a ratio of the number of F to the total number of H and F in the chemical formula of about 20% to about 60%, for example, about 25% to about 60%, about 20% to about 50%, or about 20% to about 45%. A solvent in which fluorine is substituted in this ratio is advantageous in dissolving salts, and may be suitable for use as a solvent in the solid-liquid composite electrolyte according to some embodiments.

A specific example of the fluorinated organic solvent that dissolves the salt according to some embodiments may be fluorinated 1,2-diethoxyethane, for example, 1-(2,2,2-trifluoroethoxy)-2-ethoxyethane (F3DEE), 1,2-bis(2,2-difluoroethoxy)ethane (F4DEE), 1-(2,2-difluoroethoxy)-2-(2,2,2-tri fluoroethoxy)ethane (F5DEE), 1,2-bis(2,2,2-trifluoroethoxy)ethane (F6DEE), or a combination thereof. Or, specific examples of the fluorinated organic solvent dissolving the salt may include 2,2,3,3-tetrafluoro-1,4-dimethoxybutane (FDMB), tris (2,2,2-trifluoroethyl) phosphate (TFEP), 2-(2,2,2-trifluoroethoxy)-1,3,2-dioxaphospholane 2-oxide (cyclic TFEP), tris(3-fluoropropyl) phosphate (TFPP), fluoroethylene carbonate (FEC), or a combination thereof.

### Salt

The salt may consist of a metal cation and an anion that pairs with it.

A cation in the salt may be Li⁺, Na⁺, K⁺, Mg²⁺, Al³⁺, Zn²⁺, or a combination thereof, for example, Li⁺, Na⁺, or a combination thereof, or for example, Li⁺.

An anion in the salt may be Cl⁻, CH₃COO⁻, NO₃⁻, BF₄⁻, ClO₄⁻, SO₄²⁻, OTf⁻, FSI⁻, NFSI⁻, PF₆⁻, TFSI⁻, BOB⁻DFOB⁻, or a combination thereof. Herein, OTf is trifluoromethanesulfonate, FSI is bis(fluorosulfonyl)imide, NFSI is bis(nonafluorobutanesulfonyl)imide, TFSI and is bis(trifluoromethanesulfonyl)imide. ponyl)imide, BOB is bis(oxalato)borate, and DFOB is difluorobis(oxalato)phosphate.

For example, the anion may be BF₄⁻, ClO₄⁻, OTf⁻, FSI⁻, TFSI⁻, or a combination thereof.

### Concentration of Liquid Electrolyte

The concentration of the liquid electrolyte according to some embodiments is not particularly limited. For example, the concentration of the liquid electrolyte may be about 0.5 m to about 20 m, for example about 0.5 m to about 18 m, about 0.5 m to about 15 m, about 0.5 m to about 11 m, about 0.5 m to about 10 m, about 0.5 m to about 8 m, about 0.5 m to about 7 m, or about 1 m to about 5 m.

The liquid electrolyte according to some embodiments has very low reactivity with the sulfide-based solid electrolyte even if it is not at a high concentration such as a salt-in-salt electrolyte, and therefore, when combined with a sulfide-based solid electrolyte, an ionic conductivity retention rate over the reaction time is very high, thereby providing excellent semi-solid battery performance. Accordingly, the liquid electrolyte according to some embodiments may implement a composite electrolyte that is chemically stable, have high oxidation stability, and have a very high ionic conductivity maintenance rate even within a concentration range of about 1 m to about 5 m, or about 1 m to about 3 m, or a molar concentration of about 0.5 M to about 3 M, about 0.8 M to about 2.5 M, or about 1 M to about 2.3 M.

### Other Organic Solvents

The liquid electrolyte may further include other organic solvents as needed in addition to the fluorinated organic solvent that dissolves the salt.

The other organic solvents may include, for example, a carbonate-based solvent, an ester-based solvent, an ether-based solvent, a ketone-based solvent, an alcohol-based solvent, an aprotic solvent, or a combination thereof. The organic solvent may be one type or a mixture of two or more types.

The carbonate-based solvent may be a cyclic carbonate, a chain carbonate, or a combination thereof. When the carbonate-based solvent is additionally included, the ionic conductivity of the solid-liquid composite electrolyte may be improved, and the desirable properties of the carbonate-based solvent, such as oxidation stability, heat resistance, and flame retardancy, can be secured, making it advantageous for application to actual batteries.

The carbonate-based solvent may include, for example, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or a combination thereof.

In one example, the carbonate-based solvent may include vinylene carbonate or an ethylene carbonate-based compound. The ethylene carbonate-based compound may include, for example, fluoroethylene carbonate, difluoroethylene carbonate, chloroethylene carbonate, dichloroethylene carbonate, bromoethylene carbonate, dibromoethylene carbonate, nitroethylene carbonate, cyanoethylene carbonate, or a combination thereof. As an example, the ethylene carbonate-based compound may be a halogenated ethylene carbonate, such as fluoroethylene carbonate, difluoroethylene carbonate, chloroethylene carbonate, dichloroethylene carbonate, bromoethylene carbonate, dibromoethylene carbonate, or a combination thereof.

The ester-based solvents may include, for example, methyl acetate, ethyl acetate, n-propyl acetate, dimethyl acetate, methyl propionate, ethyl propionate, γ-butyrolactone, decanolide, valerolactone, valonolactone, valerolactone, caprolactone, or a combination thereof.

The ether-based solvents may include, for example, dibutyl ether, monoglyme, diglyme, triglyme, tetraglyme, dimethoxyethane, 2-methyltetrahydrofuran, 2,5-dimethyltetrahydrofuran, tetrahydrofuran, or a combination thereof.

For example, the ether-based solvent may include a glyme-based solvent, a halogenated ether-based solvent, or a combination thereof. The halogenated ether-based solvent may be, for example, a fluorinated ether containing one or more fluorines.

The ketone-based solvent may include, for example, cyclohexanone. The alcohol-based solvent may include, for example, ethyl alcohol, isopropyl alcohol, or a combination thereof.

The aprotic solvent may include, for example, nitriles such as R—CN (R is a C2 to C20 linear, branched, or ring-structured hydrocarbon group and may include a double bond, aromatic ring, or ether group); amides such as dimethylformamide; dioxolanes such as 1,3-dioxolane and 1,4-dioxolane; sulfolanes; or a combination thereof.

Among the aprotic solvents, nitrile-based solvents may include, for example, succinonitrile, adiponitrile, suberonitrile, sebaconitrile, decanedinitrile, dodecanedinitrile, or a combination thereof.

For example, the organic solvent may include a carbonate-based solvent, an ether-based solvent, a nitrile-based solvent, or a combination thereof. Specifically, the organic solvent may include a cyclic carbonate-based solvent, a halogenated ethylene carbonate-based solvent, a glyme-based solvent, a halogenated ether-based solvent, a nitrile-based solvent, or a combination thereof. These organic solvents can improve the ionic conductivity of the composite electrolyte while simultaneously securing oxidation stability, heat resistance, and flame retardancy, and are advantageous for application to actual batteries.

### Sulfide-Based Solid Electrolyte

The sulfide-based solid electrolyte can be divided into crystalline and non-crystalline types depending on the presence or absence of a crystal structure. The crystalline types may include Thio-LISICON such as Li_{3.25}Ge_{0.25}P_{0.75}S₄, LGPS such as Li₁₀GeP₂S₁₂, and argyrodite structures such as Li₆PS₅Cl. The non-crystalline types may be divided into glass types and glass-ceramic types depending on the difference in heat treatment temperature. The glass types may include, for example, 30Li₂S·26B₂S_{3·44}LiO, 63Li₂S·36SiS₂·1Li₃PO₄, 57Li₂S·38SiS₂·5Li₄SiO₄, etc. and glass-ceramic types may include, for example, Li_{3.25}P_{0.95}S₄, Li₇P₃S₁₁.

The glass-type sulfide-based solid electrolyte, which has been actively researched by Professor Hayashi's research group in Japan, who has reported that high ionic conductivity of about 10⁻³ S/cm may be realized by mixing Li₂S₅ and P₂S₅ in a ratio of about 7:3, amorphizing them through high-energy ball milling to form a glass-type solid electrolyte, and heat-treating the glass-type solid electrolyte at a low temperature to synthesize a glass-ceramic-type electrolyte.

LGPS, one of the crystalline sulfide-based electrolytes, has been reported to exhibit high ionic conductivity of about 1.2×10⁻² S/cm at room temperature. After the report about LGPS, research on substituting Ge with Si, Sn, and Al or S with Se and the like has been explosively carried out, but all of the resultants exhibited no higher ionic conductivity than that of LGPS but had economic advantages. In addition, argyrodite type Li_{9.54}Si_{1.74}P_{1.44}S_{11.7}Cl_{0.3}, which has been reported in 2016, has recorded ionic conductivity of about 2.5×10⁻² S/cm or so, which is at the same level as that of a liquid electrolyte.

Through these various studies, the sulfide-based solid electrolyte has shown progress in improving ionic conductivity. In addition, the sulfide-based solid electrolyte has high thermal safety and is less likely to cause fire by thermal runaway. Nevertheless, the sulfide-based solid electrolyte has high reactivity with moisture and thus exhibits poor stability in the air such as formation of H₂S when exposed to the air. In addition, the sulfide-based solid electrolyte has an unstable interface in contact with a positive electrode active material and thus deteriorates cycle-life characteristics and furthermore, since it is solid, may have inevitable interfacial resistance with an electrode. For this reason, various studies for improving reactivity and interface stability of the sulfide-based solid electrolyte with moisture as well as ionic conductivity and commercializing it are being conducted.

The sulfide-based solid electrolyte may be classified into a binary structure such as an argyrodite structure, Li₂S—P₂S₅, and the like, a ternary structure such as Li₂S—GeS₂—P₂S₅ and the like, etc.

In the composite electrolyte according to some embodiments, the sulfide-based solid electrolyte may be an argyrodite-type sulfide-based solid electrolyte. The argyrodite-type solid electrolyte is one of the solid electrolytes having the same structure as Ag₉GeS₆, an ore, and exhibiting lithium ionic conductivity. Representative Li-argyrodites having Li⁺ conductivity include Li₇PS₆ and Li₆PS₅X (X═Cl, Br, or I). A method of synthesizing the argyrodite-type sulfide-based solid electrolyte in general includes mechanical milling, annealing after milling, solid sintering, a liquid method, and the like. However, the argyrodite type sulfide-based solid electrolyte is sensitive to air and humidity and thus may require difficult synthesis conditions and have a safety issue due to the use of an organic solvent and also, a problem of deteriorating electrolyte performance due to low solubility in reactants and an incomplete reaction mechanism.

One of the argyrodite types, Li₇PS₆, has been reported to have a cubic phase at a high temperature and an orthorhombic phase at a low temperature, wherein the cubic phase at a high temperature may have much improved ionic conductivity. This compound may be stabilized by replacing sulfur with a halogen anion. When substituted with the halogen element, since vacancy is formed at lithium sites inside argyrodite unit cells, lithium ionic conductivity is improved, and in addition, since the cubic phase is stabilized even at room temperature due to the substitution of the halogen ion, for example, Li₆PS₅Br and Li₆PS₅Cl may exhibit high ionic conductivity of about 10⁻³ S/cm or more. The argyrodite type sulfide-based solid electrolyte may include, for example, Li₇PS₅Br, Li₅PS₄Cl₂, Li₆PS₅Cl, Li₆PS₅Br, Li₅PS₅I, Li₇P₂S₈I, Li₄PS₄I, Li_{9.54}Si_{1.74}P_{1.44}S_{11.7}Cl_{0.3}, Li₇P_{2.9}Mn_{0.1}S_{10.7}I_{0.3}, or a combination thereof but is not limited thereto.

The sulfide-based solid electrolyte is in the form of particles, and an average particle diameter (D50) of the sulfide-based solid electrolyte particle may be less than or equal to about 5.0 μm, for example, about 0.1 μm to about 5.0 μm, about 0.5 μm to about 5.0 μm, about 0.5 μm to about 4.0 μm, about 0.5 μm to about 3.0 μm, about 0.5 μm to about 2.0 μm, or about 0.5 μm to about 1.0 μm. This sulfide-based solid electrolyte can realize high ionic conductivity and has excellent contact with the positive electrode active material and connectivity between solid electrolyte particles.

### Other Solid Electrolytes

The solid-liquid composite electrolyte according to some embodiments may further include other types of solid electrolytes in addition to the sulfide-based solid electrolyte, and may further include, for example, an oxide-based solid electrolyte, a halide-based solid electrolyte, a complex hydride, or a combination thereof.

The oxide-based inorganic solid electrolyte may include, for example, Li₁₊ₓTi₂₋ₓAl(PO₄)₃ (LTAP) (0≤x≤4), Li_{1+x+y}AlₓTi₂₋ₓSi_{y}P_{3-y}O₁₂(0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al,Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li_{z}O, LiAlO₂, Li₂O—Al₂O₃—SiO₂—P₂O₅—TiO₂—GeO₂ ceramics, Garnet type ceramics Li₃₊ₓLa₃M₂O₁₂ (M=Te, Nb, or Zr, and x is an integer of 1 to 10), or a combination thereof.

The halide-based solid electrolyte includes a halogen element as a main component, and a ratio of the halogen element to all elements constituting the solid electrolyte may be greater than or equal to about 50 mol %, greater than or equal to about 70 mol %, greater than or equal to about 90 mol %, or 100 mol %. As an example, the halide-based solid electrolyte may not contain elemental sulfur.

The halide-based solid electrolyte may contain a lithium element, a metal element other than lithium, and a halogen element. The metal element other than lithium may be, for example, Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be F, Cl, Br, I, or a combination thereof, and for example, it may be Cl, Br, or a combination thereof. The halide-based solid electrolyte may be, for example, LiₐM₁X₆ (M is Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof, X is F, Cl, Br, I, or a combination thereof, and 2≤a≤3). The halide-based solid electrolyte may include, for example, Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, or a combination thereof.

The complex hydride may be, for example, composed of a metal cation (M) and a complex-anion in the form of M′Hₙ (MM′Hₙ). The metal cation (M) may be, for example, Li, Na, K, Mg, Sc, Cu, Zn, Zr, or Hf, and the complex-anion may be [BH₄]⁻, [NH₂]⁻, [AlH₄]⁻, [NH]²⁻, [AlH₆]³⁻, or [NiH₄]⁴⁻. The complex hydride may refer to “M. Matsuo, S.-i. Orimo, Adv. Energy Mater. 2011, 1, 161”.

### Solid to Liquid Ratio

In some embodiments, the sulfide-based solid electrolyte may be included in about 10 vol % to about 99.99 vol % and the liquid electrolyte may be included in about 0.01 vol % to about 90 vol % based on 100 vol % of the solid-liquid composite electrolyte. For example, based on 100 vol % of the solid-liquid composite electrolyte, the sulfide-based solid electrolyte may be included in an amount of about 30 vol % to about 99.99 vol %, about 40 vol % to about 99.99 vol %, about 50 vol % to about 99.99 vol %, about 60 vol % to about 99.99 vol %, about 70 vol % to about 99.9 vol %, about 80 vol % to about 99.5 vol %, about 90 vol % to about 99 vol %, about 95 vol % to about 98 vol %, or about 90 vol % to about 95 vol % and the liquid electrolyte may be included in an amount of about 0.01 vol % to about 70 vol %, about 0.01 vol % to about 60 vol %, about 0.01 vol % to about 50 vol %, about 0.01 vol % to about 40 vol %, about 0.1 vol % to about 30 vol %, about 0.5 vol % to about 20 vol %, about 1 vol % to about 10 vol %, about 2 vol % to about 5 vol %, or about 5 vol % to about 10 vol %.

A weight ratio of the sulfide-based solid electrolyte and the liquid electrolyte may vary depending on the concentration of the liquid electrolyte. For example, based on 100 wt % of the solid-liquid composite electrolyte, the sulfide-based solid electrolyte may be included in an amount of about 50 wt % to about 99.99 wt % and the liquid electrolyte may be included in an amount of about 0.01 wt % to about 50 wt %. For example, based on 100 wt % of the solid-liquid composite electrolyte, the sulfide-based solid electrolyte may be included in an amount of about 30 wt % to about 99.99 wt %, about 40 wt % to about 99.99 wt %, about 50 wt % to about 99.99 wt %, about 60 wt % to about 99.99 wt %, about 70 wt % to about 99.99 wt %, about 80 wt % to about 99.99 wt %, about 90 wt % to about 99.99 wt %, about 95 wt % to about 99.99 wt %, about 99 wt % to about 99.99 wt %, about 90 wt % to about 99.9 wt %, or about 90 wt % to about 99 wt % and the liquid electrolyte may be included in an amount of about 0.01 wt % to about 70 wt %, about 0.01 wt % to about 60 wt %, about 0.01 wt % to about 50 wt %, about 0.01 wt % to about 40 wt %, about 0.01 wt % to about 30 wt %, about 0.01 wt % to 20 wt %, about 0.01 wt % to about 10 wt %, about 0.01 wt % to about 5 wt %, about 0.01 wt % to about 1 wt %, about 0.1 wt % to about 10 wt %, or about 1 wt % to about 10 wt %.

If the content of the liquid electrolyte in the solid-liquid composite electrolyte is excessive, battery safety may not be guaranteed due to loss of flame retardancy due to the liquid electrolyte or an inherent risk of battery explosion, and if the content of the liquid electrolyte is too low, the disadvantages of solid electrolytes cannot be overcome and ionic conductivity may decrease or cycle-life characteristics may deteriorate. When the sulfide-based solid electrolyte and liquid electrolyte satisfy the above-mentioned content range, solid and liquid can be easily combined, high ionic conductivity can be maintained, and battery safety can be ensured.

In some embodiments, the liquid electrolyte, which is applied in a very small content to that of the sulfide-based solid electrolyte, may effectively solve the problems of the ionic conductivity deterioration, the resistance increase, and the like due to the solid electrolyte and also, realize high voltage oxidation stability, flame retardancy, and safety as well as an excellent ionic conductivity maintenance rate. For example, when the liquid electrolyte is included in an amount of less than or equal to about 15 vol %, less than or equal to about 10 vol %, less than or equal to about 5 vol %, or less than or equal to about 1 vol % based on 100 vol % of the solid-liquid composite electrolyte, the sulfide-based solid electrolyte and the liquid electrolyte may be easily combined, improving ionic conductivity, oxidation safety, and cycle-life characteristics by the liquid electrolyte of some embodiments as well as securing safety of the solid electrolyte.

### Other Components

The composite electrolyte according to some embodiments may further include other binders, an organic dispersant, an ionic liquid, a conductive polymer, and additives.

The binder may include, for example a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a natural rubber, polybutadiene, polydimethylsiloxane, polyethyleneoxide, polyvinylpyrrolidone, polyvinylpyridine, chlorosulfonatedpolyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyvinylidene fluoride-hexafluoropropylene copolymer, polyvinylchloride, carboxylated polyvinylchloride, polyvinylfluoride, polyurethane, a copolymer thereof, or a combination thereof.

The solid-liquid composite electrolyte according to some embodiments may be in the form of a type of pellet or a film. The solid-liquid composite electrolyte can be applied to various positions in the battery. For example, it may be mixed with a positive electrode active material to form a positive electrode, a solid electrolyte film, or mixed with a negative electrode active material to form a negative electrode.

### Composite Electrolyte Film

Some embodiments may provide a composite electrolyte film including the above solid-liquid composite electrolyte. The composite electrolyte film may have, for example, a thickness of about 20 μm to about 1000 μm, about 20 μm to about 800 μm, about 20 μm to about 700 μm, or about 20 μm to about 600 μm. The composite electrolyte film according to some embodiments is disposed between positive and negative electrodes and thus may secure battery safety as well as realize high ionic conductivity and thereby, improve cycle-life characteristics and rate capabilities of a battery.

### Semi-Solid Secondary Battery

Some embodiments provide a semi-solid secondary battery including a positive electrode, a negative electrode, and the aforementioned solid-liquid composite electrolyte. At this time, the solid-liquid composite electrolyte may be disposed between the positive electrode and the negative electrode. However, the liquid electrolyte in the solid-liquid composite electrolyte may be impregnated not only in the solid-liquid composite electrolyte but also in the positive electrode and/or negative electrode.

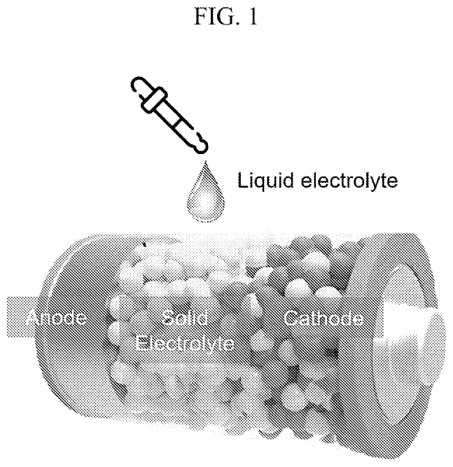

For easy understanding, a shape of a semi-solid secondary battery according to some embodiments is shown in FIG. 1. Although FIG. 1 shows one electrode assembly including the negative electrode, composite electrolyte film, and positive electrode, a semi-solid secondary battery can also be manufactured by stacking two or more electrode assemblies.

### Negative Electrode

The negative electrode may be a general negative electrode containing various negative electrode active materials such as carbon-based, silicon-based, etc.; it may be a negative electrode made of metal such as lithium metal; or it may be a precipitated negative electrode that acts as a negative electrode active material wherein the negative electrode active material is not initially present, but lithium metal, etc. is precipitated during charging.

As an example, the negative electrode may include a current collector and a negative electrode active material layer on the current collector. The negative electrode active material layer includes a negative electrode active material, may further include a binder and/or a conductive material, and may optionally include the aforementioned composite electrolyte.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. Examples of crystalline carbon may include natural graphite, artificial graphite, or a combination thereof, and examples of amorphous carbon include soft carbon or hard carbon, a mesophase pitch carbonized product, and calcined coke. The carbon-based negative electrode active material may be amorphous, plate-shaped, flake-shaped, spherical, or fibrous.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a silicon alloy, and the like and the Sn-based negative electrode active material may include Sn, SnO₂, a tin alloy, and the like. At least one of these materials may be mixed with SiO₂. For example, the negative electrode active material may include a composite of silicon and carbon.

The binder may be a water-insoluble binder, a water-soluble binder, or a combination thereof.

The water-insoluble binder may include polyvinylchloride, carboxylated polyvinylchloride, polyvinylfluoride, an ethylene oxide-containing polymer, ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The water-soluble binder may include a rubber binder or a polymer resin binder. The rubber-based binder may be selected from a nitrile butadiene rubber, a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, polybutadiene, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound may be further included as a type of thickener. As the cellulose-based compound, one or more of carboxymethyl cellulose, hydroxypropylmethyl cellulose, methyl cellulose, or alkali metal salts thereof may be mixed and used. The alkali metal may be Na, or Li.

The conductive material may be, for example, a carbon-based material such as natural graphite, artificial graphite, carbon black, acetylene black, ketjen black, a carbon fiber, a carbon nanofiber, or a carbon nanotube; a metal-based material of a metal powder or a metal fiber including copper, nickel, aluminum silver, and the like; or a conductive polymer such as a polyphenylene derivative; or a mixture thereof.

### Positive Electrode

The positive electrode may include a current collector and a positive electrode active material layer on the current collector, and the positive electrode active material layer may include a positive electrode active material and optionally may include a solid electrolyte. The positive electrode active material layer may optionally further include a binder and/or a conductive material.

### Positive Electrode Active Material

The positive electrode active material can be applied without limitation as long as it is commonly used in secondary batteries. For example, the positive electrode active material may be a compound capable of reversible intercalation and deintercalation of lithium, and may include, for example, a lithium transition metal composite oxide.

The positive electrode active material may include, for example, lithium nickel-based oxide, lithium cobalt-based oxide, lithium manganese-based oxide, lithium iron phosphate-based compound, cobalt-free nickel-manganese-based oxide, or a combination thereof, and may include, for example, lithium nickel oxide (LNO), lithium cobalt oxide (LCO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), lithium iron phosphate (LFP), or a combination thereof.

The positive electrode active material may be included in an amount of about 55 wt % to about 99.5 wt %, for example about 65 wt % to about 95 wt %, or about 75 wt % to about 91 wt % based on 100 wt % of the positive electrode active material layer.

### Binder

The binder serves to adhere the positive electrode active material particles to each other and to the current collector. Examples of the binder may include a nitrile butadiene rubber, polybutadiene, polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto. An amount of the binder in 100 wt % of the positive electrode active material layer may be approximately about 0.1 wt % to about 5 wt %.

### Conductive Material

The conductive material may include a carbon-based material such as natural graphite, artificial graphite, carbon black, acetylene black, ketjen black, a carbon fiber, a carbon nanofiber, carbon nanotube, and the like; a metal-based material of a metal powder or a metal fiber including copper, nickel, aluminum, silver, and the like; a conductive polymer such as a polyphenylene derivative; or a mixture thereof. In 100 wt % of the positive electrode active material layer, an amount of the conductive material may be about 0 wt % to about 3 wt %, or about 0.01 wt % to about 2 wt %.

The positive electrode active material layer may further include the aforementioned solid-liquid composite electrolyte in addition to the positive electrode active material, binder, and conductive material. In this case, the solid-liquid composite electrolyte may be included in an amount of about 0.1 wt % to about 45 wt %, for example, about 1 wt % to about 35 wt %, about 5 wt % to about 30 wt %, about 8 wt % to about 25 wt %, or about 10 wt % to about 20 wt % based on 100 wt % of the positive electrode active material layer.

The shape of the semi-solid secondary battery is not particularly limited, and may be, for example, coin-shaped, button-shaped, sheet-shaped, stacked-shaped, cylindrical, etc. The semi-solid secondary battery according to some embodiments can be applied to various electronic devices, such as electric vehicles and power storage devices.

Hereinafter, examples of the present invention and comparative examples are described. It is to be understood, however, that the examples are for the purpose of illustration and are not to be construed as limiting the present invention.

### EXAMPLE 1

150 mg of an argyrodite-type sulfide-based solid electrolyte (Li₆PS₅Cl) was prepared and pressed at 370 MPa for 1 minute and then, stabilized at 74 MPa for 12 hours to prepare a solid electrolyte pellet with a thickness of about 600 μm or less and an area of 1.33 cm².

A liquid electrolyte was prepared by dissolving LiFSI at a molar concentration of 1 molal concentration in 1,2-bis(2,2-difluoroethoxy)ethane (F4DEE) organic solvent.

40 μ [symbol] of the liquid electrolyte was dropped on the solid electrolyte pellet and then maintained for 10 minutes to prepare a solid-liquid composite electrolyte. Herein, an amount of the liquid electrolyte was about 10 vol % based on 100 vol % of the solid-liquid composite electrolyte.

### EXAMPLES 2 TO 10 AND COMPARATIVE EXAMPLES 1 TO 13

Each solid-liquid composite electrolyte was prepared in the same manner as in Example 1 except that types of organic solvents, types of salts, and concentrations were changed as shown in Table 1.

### Evaluation Example 1: Evaluation of Ionic Conductivity Changes

In the solid-liquid composite electrolytes of Examples 1 to 10 and Comparative Examples 1 to 13, the ionic conductivity was measured 72 hours after adding each liquid electrolyte to the sulfide-based solid electrolyte, and ratios of the ionic conductivity (σ_{HE}) of the composite electrolyte after 72 hours to the ionic conductivity (σ_{SE}) of the sulfide-based solid electrolyte was calculated and shown in Table 1.

TABLE 1

| | | Normalized ionic |
|---|---|---|
| | Composition of | conductivity after |
| | liquid electrolyte | 72 hours (σ_{HE}/σ_{SE}) |
| Example 1 | 1 m LiFSI in F4DEE | 1.3851 |
| Example 2 | 1 m LiTFSI in F4DEE | 1.1798 |
| Example 3 | 1 m LiPF₆ in F4DEE | 1.3405 |
| Example 4 | 1 m LiFSI in FDMB | 1.0372 |
| Example 5 | 1 m LiFSI in TFEP | 1.2044 |
| Example 6 | 1 m LiTFSI in TFEP | 1.0427 |
| Example 7 | 1 m LiBF₄ in TFEP | 1.1986 |
| Example 8 | 3 m LiFSI in PC/FEC | 1.0395 |
| | (v/v = 93/7) | |
| Example 9 | 5.5 m LiFSI in PC/FEC | 1.1474 |
| Example 10 | 2 m LiTFSI in PC/FEC | 1.0163 |
| Comparative | 4.3 m LITFSI in G1 | 0.8043 |
| Example 1 | | |
| Comparative | 4.3 m LiBF₄ in G1 | 0.8452 |
| Example 2 | | |
| Comparative | 1 M LITFSI in G3 | 0.55 |
| Example 3 | | |
| Comparative | TTE (not dissociate) | 0.79 |
| Example 4 | | |
| Comparative | 1 m LiFSI in EC/PC | 0.9421 |
| | (v/v = 1/1) | |
| Comparative | 1 m LiTFSI in EC/PC | 0.7022 |
| Example 6 | | |
| Comparative | 2 m LiTFSI in EC/PC | 0.9165 |
| Example 7 | | |
| Comparative | 4.3 m LiTFSI in EC/PC | 0.7468 |
| Example 8 | | |
| Comparative | 1 m LiBF₄ in EC/PC | 0.4276 |
| Example 9 | | |
| Comparative | 2 m LiBF₄ in EC/PC | 0.7705 |
| Example 10 | | |
| Comparative | 4.3 m LiBF₄ in EC/PC | 0.8485 |
| Example 11 | | |
| Comparative | 4.3 m LiBF₄ in SBN | 0.8573 |
| Example 12 | | |
| Comparative | 6 m LiBF₄ in SBN | 0.9581 |
| Example 13 | | |

In Table 1, F4DEE is 1,2-bis(2,2-difluoroethoxy)ethane, FDMB is 2,2,3,3-tetrafluoro-1,4-dimethoxybutane, TFEP is tris(2,2,2-trifluoroethyl)phosphate, PC is propylene carbonate, FEC is fluoroethylene carbonate, G1 is dimethoxyethane, G3 is triethylene glycol dimethyl ether, TTE is 1,1,2,2-tetrafluoroethyl-2,2,3,3-tetrafluoropropyl ether, EC is ethylene carbonate, and SBN is sebaconitrile.

Referring to Table 1, the ionic conductivity ratios of the composite electrolyte Examples 1 to 10 after 72 hours compared to the ionic conductivity of the sulfide-based solid electrolyte all satisfied a value exceeding 1. That is, this means that the composite electrolytes of the examples implement a higher ionic conductivity than the ionic conductivity of the solid electrolyte itself, and it is interpreted that the liquid electrolytes used in the examples do not have high viscosity, so that they are effectively impregnated into the pores between solid electrolyte particles, further improving ion conduction performance. In addition, the liquid electrolytes of the examples have low reactivity with the sulfide-based solid electrolyte, so that even 72 hours after combination, the tendency of the sulfide-based solid electrolyte to deteriorate due to side reactions is very low, and thus, it is understood that high ionic conductivity can be maintained for a long time.

In the case of the composite electrolytes of comparative examples, the reactivity between the added liquid electrolyte and the sulfide-based solid electrolyte was generally high, and the ionic conductivity was found to be lower than that of the sulfide-based solid electrolyte itself. In Comparative Example 4, the lithium salt did not dissociate in the TTE solvent, so only the TTE solvent was added to the solid electrolyte to evaluate the change in ionic conductivity. After 72 hours, the ionic conductivity ratio was found to be as low as 0.79, which is similar to that of the TTE solvent. It is understood that ionic conductivity is reduced due to reactivity with sulfide-based solid electrolyte. In the case of Comparative Examples 1, 2, 8, and 11 to 13 in which the concentrations of the liquid electrolytes were high, over 4.3 m, after 72 hours, not only was the ionic conductivity of the composite electrolytes lower than that of the solid electrolyte itself, but due to the high viscosity of the liquid electrolyte, processability is poor, and the cost increases due to the use of excessive lithium salt, which limits commercialization. In addition, for example, if a liquid electrolyte is produced by dissociating lithium salt at a high concentration of 15.5 m in G1 solvent, the reactivity with the sulfide-based solid electrolyte can be lowered, but the concentration of the liquid electrolyte is so high that it is difficult to inject into the battery, which reduces processability, and the cost due to the use of excessive lithium salt increases excessively, making it difficult to apply to actual industry.

### Evaluation Example 2: Evaluation of Oxidation Stability

Meanwhile, the current density characteristics according to voltage were analyzed for each of the liquid electrolytes used in Examples 1, 4, 8, and 9 and Comparative Example 1 by linear sweep voltammetry (LSV). The voltage range where the current density rises rapidly was about 4.3 V for Comparative Example 1, while it was analyzed as 5.2 V for Example 1, 5.2 V for Example 4, 5.1 V for Example 8, and 5.4 V for Example 9, which indicate that the high-voltage oxidation stability of the liquid electrolyte applied to the composite electrolyte of the examples is superior, and that stable operation of the semi-solid battery is possible even in the high voltage region.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. A solid-liquid composite electrolyte, comprising
a sulfide-based solid electrolyte and a liquid electrolyte,
wherein the liquid electrolyte includes a salt and fluorinated organic solvent that dissolves the salt.

2. The solid-liquid composite electrolyte of claim 1, wherein
an ionic conductivity of a solution in which the salt is dissolved using only a fluorinated organic solvent dissolving the salt as the sole solvent is greater than or equal to about 1×10⁻⁴ S/cm.

3. The solid-liquid composite electrolyte of claim 1, wherein
a concentration of a solution in which the salt is dissolved using only the fluorinated organic solvent that dissolves the salt as the sole solvent is greater than or equal to about 0.1 m.

4. The solid-liquid composite electrolyte of claim 1, wherein
the fluorinated organic solvent that dissolves the salt includes fluorinated ether, fluorinated phosphate, fluorinated carbonate, or a combination thereof.

5. The solid-liquid composite electrolyte of claim 1, wherein
the fluorinated organic solvent that dissolves the salt has a ratio of the number of F to the total number of H and F in the chemical formula of about 20% to about 60%.

6. The solid-liquid composite electrolyte of claim 1, wherein
the fluorinated organic solvent that dissolves the salt is fluorinated 1,2-diethoxyethane, for example, 1-(2,2,2-trifluoroethoxy)-2-ethoxyethane (F3DEE), 1,2-bis(2,2-difluoroethoxy)ethane (F4DEE), 1-(2,2-difluoroethoxy)-2-(2,2,2-tri fluoroethoxy)ethane (F5DEE), 1,2-bis(2,2,2-trifluoroethoxy)ethane (F6DEE), or a combination thereof.

7. The solid-liquid composite electrolyte of claim 1, wherein
a cation in the salt is Li⁺, Na⁺, K⁺, Mg²⁺, Al³⁺, Zn²⁺, or a combination thereof and an anion is Cl⁻, CH₃COO⁻, NO₃⁻, BF₄⁻, ClO₄⁻, SO₄²⁻, OTf⁻, FSI⁻, NFSI⁻, PF₆⁻, TFSI⁻, BOB⁻, DFOB⁻, or a combination thereof.

8. The solid-liquid composite electrolyte of claim 1, wherein
the liquid electrolyte has a molal concentration of about 0.5 m to about 20 m.

9. The solid-liquid composite electrolyte of claim 1, wherein
the liquid electrolyte further includes other organic solvents in addition to the fluorinated organic solvent that dissolves the salt,
the other organic solvent includes a carbonate-based solvent, an ester-based solvent, an ether-based solvent, a ketone-based solvent, an alcohol-based solvent, an aprotic solvent, or a combination thereof.

10. The solid-liquid composite electrolyte of claim 1, wherein
the sulfide-based solid electrolyte is in the form of particles, and an average particle diameter (D₅₀) of the particles is about 0.1 μm to about 5 μm.

11. The solid-liquid composite electrolyte of claim 1, wherein
the sulfide-based solid electrolyte is an argyrodite-type sulfide-based solid electrolyte.

12. The solid-liquid composite electrolyte of claim 1, wherein
the solid-liquid composite electrolyte includes an oxide-based solid electrolyte, a halide-based solid electrolyte, a complex hydride, or a combination thereof.

13. The solid-liquid composite electrolyte of claim 1, wherein
based on 100 vol % of the solid-liquid composite electrolyte, the sulfide-based solid electrolyte is included in an amount of about 10 vol % to about 99.99 vol % and the liquid electrolyte included in an amount of about 0.01 vol % to about 90 vol %.

14. The solid-liquid composite electrolyte of claim 1, wherein
based on 100 vol % of the solid-liquid composite electrolyte, the sulfide-based solid electrolyte is included in an amount of about 70 vol % to about 99.99 vol % and the liquid electrolyte included in an amount of about 0.01 vol % to about 30 vol %.

15. The solid-liquid composite electrolyte of claim 1, wherein
based on 100 vol% of the solid-liquid composite electrolyte, the sulfide-based solid electrolyte is included in an amount of about 85 vol % to about 99 vol % and the liquid electrolyte is included in an amount of about 1 vol % to about 15 vol %.

16. The solid-liquid composite electrolyte of claim 1, wherein
the solid-liquid composite electrolyte includes a plurality of sulfide-based solid electrolyte particles, and a liquid electrolyte in the pores between the particles.

17. A semi-solid secondary battery, comprising
a positive electrode,
a negative electrode, and
a composite electrolyte film of claim 1 between the positive electrode and the negative electrode.

18. The semi-solid secondary battery of claim 17, wherein
the solid-liquid composite electrolyte is present between the positive electrode and the negative electrode, and
the liquid electrolyte is impregnated not only within the solid-liquid composite electrolyte but also within the positive electrode and/or negative electrode.

19. The semi-solid secondary battery of claim 17, wherein
the positive electrode includes a positive electrode active material including a lithium transition metal composite oxide, and
the negative electrode includes a carbon-based negative electrode active material or lithium metal.
